(19) United States
(12) Patent Application Publication
(10) Pub. No.: US 2015/0282676 A1
(43) Pub. Date: Oct. 8, 2015

(54) ATTACHMENT CAP UNIT FOR SHOWER

(71) Applicant: Jinwook Lee, Goyang-si (KR)

(72) Inventor: Jinwook Lee, Goyang-si (KR)

(21) Appl. No.: 14/439,665

(22) PCT Filed: Mar. 4, 2014
(86) PCT No.: PCT/KR2014/001737

§ 371 Date: Apr. 30, 2015

(30) Foreign Application Priority Data
Jun. 24, 2013 (KR) 20-2013-0005081

(51) Int. Cl. A47K 3/28; A61H 35/00; B05B 1/18

(52) U.S. Cl. CPC A47K 3/28; B05B 1/18; A61H 35/008; A45D 2019/0033

(57) ABSTRACT

Disclosed is an attachment cap unit for shower. The attachment cap unit includes: a head fix unit surrounding the outside of a shower head which sprays water through a plurality of injection holes formed on one side of the shower head; a scalp contact unit which is made from an elastic soft material at the lower end of the head fix unit and which is formed to be in close contact with the scalp such that the end edge portion thereof extends downwardly below one side of the shower head on which the injection holes are formed; a drainpipe provided in the head fix unit; a hose which is connected to the drainpipe for guiding water sprayed from the injection holes of the shower head to the outside; and an elastic protrusion attached onto one side of the shower head on which the injection holes are formed.

### FIELD OF THE INVENTION

The present invention relates to an attachment cap for shower, more particularly, to an attachment cap unit for shower that can remove foreign materials from hair or the scalp and also have an effect of acupressure or massage for hair or the scalp.

### DESCRIPTION OF THE RELATED ART

In general, a shower is an injection device having a shape of watering pot for spraying cold water or warm water, and is broadly using for home use such as a bathroom, a sink, and a bathtub etc. and also for business use such as a body shower, a water-pool, a softener, and a bathtub etc.

A handle of this shower is connected to an end of hose that is connected to a water pipe, and a head having a plurality of injection holes is formed at the end of the handle and have a structure for thinly spraying water in many streams.

Recently, a showers are proposed that have an effect such as a massage by patting a skin of a user with a water pressure as well as a cleaning by spraying water to the body of the user. Since the conventional showers using a water pressure need a high water pressure for a massage effect, it use a lot of water and also need an additional installation of facilities for spraying water with the high water pressure. Accordingly, there is a problem that installation and maintenance costs are occurred.

As the present invention designed to solve the above described problem, it is an object of the present invention to provide a shower cap unit that is simply and detachably installed on a shower head or is manufactured with an integral shape. It is another object of the present invention to provide a shower cap unit that has a function to remove foreign materials attached hair or a scalp by using a water sprayed from the shower head along with a massage function by protrusion. It is yet another object of the present invention to prevent the water sprayed from the shower head from flowing to the unwanted direction, thereby preventing a shoulder or a body of the user who is washing from being wet.

To solve the above problems, the attachment cap unit of the present invention is comprised of a head fix unit surrounding the outside of a shower head that water is being sprayed through a plurality of injection holes formed at one side; a scalp contact unit that a part of end rim is downwardly formed more longer than one side of the shower head that the injection holes is formed; a drainpipe equipped on the head fix unit; and a hose that is connected to the drainpipe and guides a water drained from the injection holes of the shower head to the outside.

Herein, an elastic protrusion may be attached on one side of the shower head, or a plurality of contact protrusion may be formed at the inside of the scalp contact unit.

In addition, the attachment cap unit may be comprised of a head fix unit surrounding the outside of a shower head that water is being sprayed through a plurality of injection holes formed at one side; a scalp contact unit that is formed at the bottom of the head fix unit with a soft materials and a part of end rim is downwardly formed more longer than one side of the shower head that the injection holes is formed; a drainpipe equipped on one of the head fix unit and the scalp contact unit; a hose that is connected to the drainpipe and guides a water drained from the injection holes of the shower head to the outside, a shaft installed across the inside of the head fix unit, a propeller that is installed on the shaft and near the drainpipe, thereby rotating the shaft by using a pressure of water drained to the drainpipe; and a rotatable protrusion that is installed on the shaft and is being rotated along with the shaft when the shaft is being rotated.

### SUMMARY OF THE INVENTION

According to the present invention, the attachment cap unit prevents a water from flowing to an unwanted place by tightly contacting a scalp contact unit to a scalp, and also there is an advantage that the water may be guided to a drainpipe for draining of the water.

In addition, foreign materials attached on a scalp may be removed by moving a scalp contact unit on the scalp, and also there is an advantage that is able to have an effects such as acupressure or massage with an elastic protrusion or a contact protrusion or a rotatable protrusion.

In addition, when a user washes out a hairdye, there is an advantage that is able to prevent a strong hairdye from spattering on a user's eyes, ears, and face etc.

In addition, when a user washes out soap and a hairdye etc., there is an advantage that an amount of water may be saved, and thus an energy used to heat the water in winter also may be saved.

According to the present invention, in case of washing of the hair in a hair salon, the attachment cap unit has an advantage that a water or a hairdye etc. is not splashed on the eyes, nose, mouth, etc. of the customer, and it is also possible to substitute an existing work done by hands to the attachment cap unit.

The attachment cap unit is also able to be used to have an effects of a scalp massage, washing of the hair, and general shower etc.

The attachment cap unit is also able to be used for the multi-purpose such as a bath of pets.

### BRIEF DESCRIPTION OF THE DRAWINGS

FIG. 1 is a perspective view showing an embodiment of an attachment cap and a shower head according to the present invention.

FIG. 2 is a perspective view showing an embodiment of a couple of the attachment cap and the shower head.

FIG. 3 is a view showing a spray of water toward one side of the attachment cap shown in FIG. 2.

FIG. 4 is a view showing a drainage groove formed on the attachment cap according to the present invention.

FIG. 5 is a view showing a drainpipe formed on the attachment cap according to the present invention.

FIG. 6 is a view showing a rotatable protrusion formed on the attachment cap according to the present invention.

FIG. 7 is a section view of the attachment cap shown in FIG. 6.

FIG. 8 is a view showing an elastic protrusion formed on the attachment cap according to the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below in order to explain the aspects of embodiments of the present invention by referring to the figures.

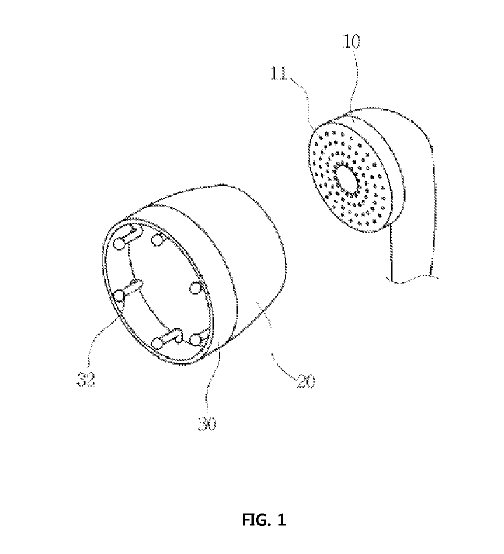

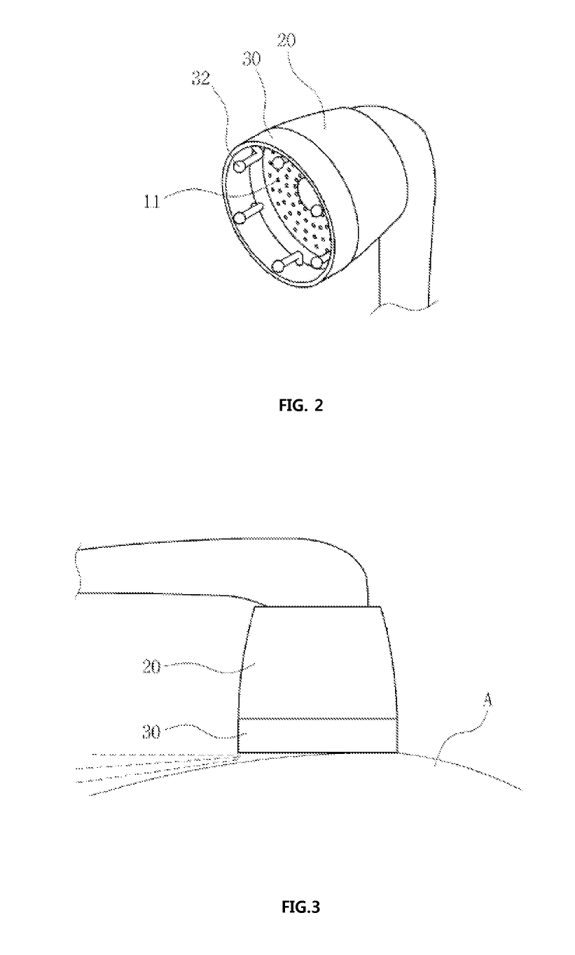

FIG. 1 is a perspective view showing an embodiment of an attachment cap and a shower head according to the present invention, FIG. 2 is a perspective view showing an embodiment of a couple of the attachment cap and the shower head, and FIG. 3 is a view showing a spray of water toward one side of the attachment cap shown in FIG. 2.

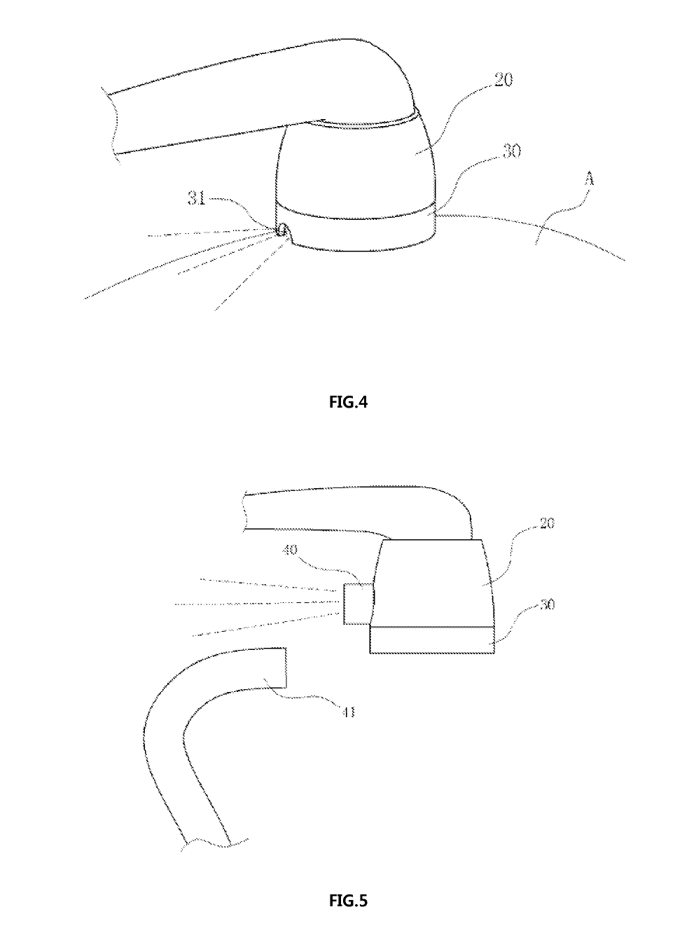

And, FIG. 4 is a view showing a drainage groove formed on the attachment cap according to the present invention, and FIG. 5 is a view showing a drainpipe formed on the attachment cap according to the present invention.

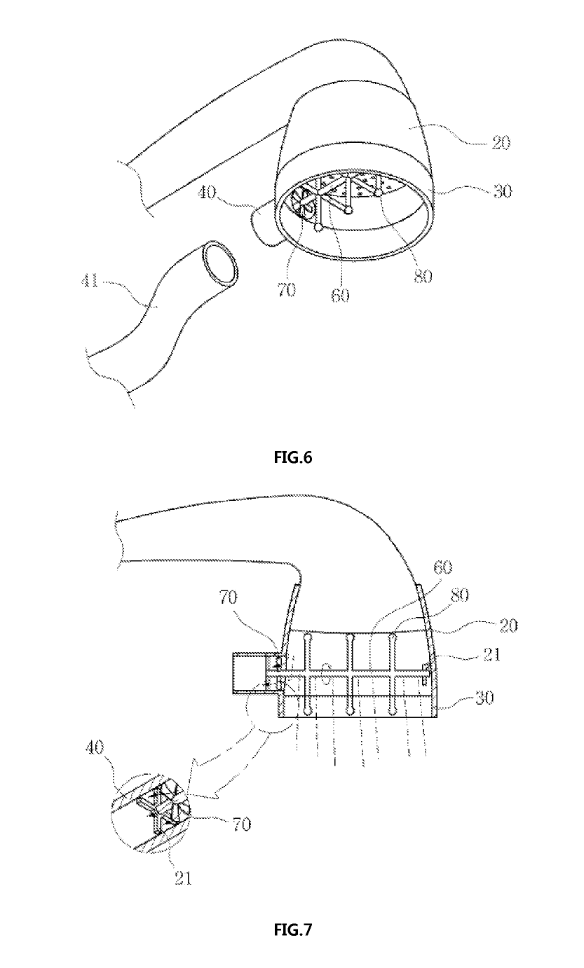

In addition, FIG. 6 is a view showing a rotatable protrusion formed on the attachment cap according to the present invention, and FIG. 7 is a section view of the attachment cap shown in FIG. 6.

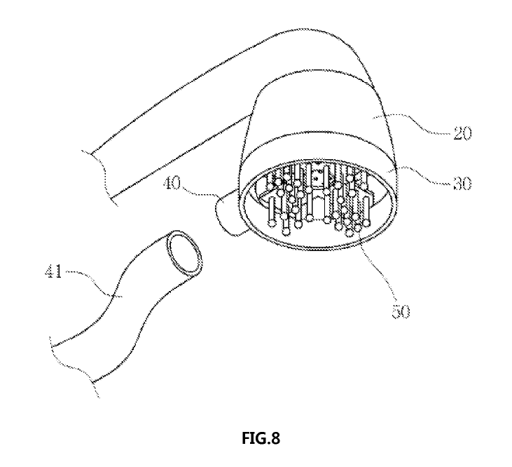

In addition, FIG. 8 is a view showing an elastic protrusion formed on the attachment cap according to the present invention.

According to the present invention, an attachment cap unit is designed to remove foreign materials attached on hair and a scalp (A), with having an effect of acupressure or massage. The attachment cap unit is comprised of a head fix unit (20) surrounding the outside of a shower head (10), a scalp contact unit (30) formed at the bottom of the head fix unit (20), and a drainpipe equipped on one of the head fix unit (20) or the scalp contact unit (30).

As everyone knows, the shower head (10) has a plurality of injection holes formed on one side, and a water is sprayed through the injection holes.

The head fix unit (20) has a structure that the upper of the head fix unit (20) surrounds and is tightly contacted to the outside of the shower head (10) to prevent a water from leaking to the upper side and the bottom is opened. The head fix unit (20) may be made from a hard synthetic resin or a soft synthetic resin. And, the head fix unit (20) has a structure that a bottom rim part of the head fix unit (20) is positioned at the lower side than one side of the shower head (10) formed the injection holes. In addition, the head fix unit (20) may be manufactured to tightly be coupled the inside with the outside of the shower head (10) from the first, or may be separately manufactured to have an attachable structure.

The scalp contact unit (30) is made from a soft synthesis resin having an elastic force such as a silicon at the bottom of the head fix unit (20), and is tightly contacted on a head (scalp) of the people who wash out their hair at a beauty salon or a barber shop etc. In other words, since the scalp contact unit (30) is made from a soft materials, it may be contacted on the scalp (A) by applying a certain pressure, thereby preventing a water from flowing to a shoulder or a body etc. of the people who wash out their hair. Additionally, since a bottom rim part of the scalp contact unit (30) is downwardly formed more longer than one side of the shower head (10) that the injection holes is formed and is tightly contacted on the scalp (A), a certain space is formed between the scalp (A) and one side of the shower head (10) formed the injection holes (11).

The drainpipe (40) is protruded at one side of the head fix unit (20), and it is formed at the bottom lower than one side of the shower head (10) formed the injection holes (11). That is, since the head fix unit (20) surrounds the shower head (10) and a bottom rim part is also positioned at the lower side than one side of the shower head (10) formed the injection holes (11), it is divided into one part that is contacted to the outside and the other part that is not contacted to the outside. From among these, the drainpipe is formed at the lower part than one side of the shower head (10), that is, at the bottom of the head fix unit (20) that is not contacted to the outside of the shower head (20). A flexible hose (41) is detachably connected to the drainpipe (40), and thus a water drained through the drainpipe is guided to a certain position through a hose (41). When a user use an attachment cap unit according to the present invention, the user tightly contact the scalp contact unit (30) to his head. In this case, a sprayed water is full filled in the internal space between the head fix unit (20) and the scalp contact unit (30). When the water is full filled in the internal space between the head fix unit (20) and the scalp contact unit (30), the water should be drained to the outside through the drainpipe (40). If there is not the drainpipe (40), the user should slightly lift up a part of the scalp contact unit (30) tightly contacted on a head of the user to drain the water to the outside as shown in FIG. 3. Accordingly, the drainpipe (40) is formed to remove this inconvenience.

Herein, when the drainpipe is not equipped with the head fix unit (20), it is also possible to form a drainage groove (31) at one side of the scalp contact unit (30) as shown in FIG. 4.

The drainpipe (40) and the drainage groove (31) is formed at the best position that a water is not splashed to a user who washes out his hair. And, the drainpipe (40) may be formed on the scalp contact unit (30) in accordance with the case.

Meanwhile, an attachment cap unit may be further comprised of an elastic protrusion (50) or a contact protrusion (32).

As shown in FIG. 8, the elastic protrusion (50) is attached on one side of the shower head (10) formed the injection holes (11)

As shown in FIG. 1 to FIG. 2, a plurality of contact protrusion (32) is separated from each other at the inner side of the scalp contact unit (30).

Since the elastic protrusion (50) or the contact protrusion (32) will be contacted on the scalp (A) in the inside of the scalp contact unit (30) when the scalp contact unit (30) is tightly contacted on the scalp (A), it is able to massage the scalp (A) or remove foreign materials from the hair or the scalp (A). And, it is desirable that the elastic protrusion (50) or the contact protrusion (32) should be made from a soft synthesis resin having a certain elasticity.

Since the elastic protrusion (50) or the contact protrusion (32) performs the same function each other, in case of attaching the elastic protrusion (50) to the shower head (10), the contact protrusion (32) is not formed on the scalp contact unit (30), and in case of attaching the contact protrusion (32) to the scalp contact unit (30), the elastic protrusion (50) is not formed on the shower head (10).

And, when there is no the elastic protrusion (50) or the contact protrusion (32), the scalp may be massaged by forming a rotatable protrusion (80).

In other words, as shown in FIG. 6 to FIG. 7, the attachment cap unit of the present invention is further comprised of a shaft (60), a propeller (70) and the rotatable protrusion (80).

The shaft (60) is installed across the inside of the head fix unit (20). In detail, a coupling anchor (21) is protruded at the both inside of the head fix unit (20) to face each other, and both end of the shaft (60) are rotatably installed at the two coupling anchors (21). Additionally, any one of the two anchors (21) may be installed at the inside of the drainpipe (40) or near the drainpipe (40), and it is desirable that the installed coupling anchors (21) should be formed as a (+) or cross-shape for the purpose of easy drainage of a water used to rotate the propeller (70).

The propeller (70) is installed on the shaft (60), especially is installed on near the drainpipe among the outside surfaces of the long shaft (60). By installing the propeller (70) on near the drainpipe (40), when a water is drained through the drainpipe (40) to the outside of the head fix unit (20) and the scalp contact unit (30), the shaft (60) will be rotated with the propeller (70) by making the propeller (70) to be more easily rotated with a drain water pressure.

The rotatable protrusion (80) is installed on the shaft (50), and thus it is rotated with a rotation of the shaft (60). A plurality of rotatable protrusion (80) is installed at regular intervals along the length direction of the shaft (60), thereby having a radial shape. As described in the above, the shaft (60) is rotated along with the propeller (70) that is rotated by a pressure of water drained to the drainpipe (40), and thus the rotatable protrusion (8) also is rotated along with the shaft (60).

Consequently, in a state that the scalp contact unit (30) is being pressurized to a head of the user who is washing out hair or a scalp, if the water is being drained to the drainpipe (40), it is able to remove foreign materials from a head of the user, that is, hair and the scalp and massage them due to continuous pressurization.

It is to be understood that the above description is illustrative of the present invention and is not to be construed as limiting the invention. Various modifications and applications may occur to those skilled in the art without departing from the true spirit and scope of the present invention as defined by the appended claims.

Description of the Reference Numerals

| | |
|---|---|
| 10: shower head | 11: injection holes |
| 20: head fix unit | 21: coupling anchor |
| 30: scalp contact unit | 21: drainage groove |
| 32: contact protrusion | 40: drainpipe |
| 41: hose | 50: elastic protrusion |
| 60: shaft | 70: propeller |
| 80: rotatable protrusion | A: scalp |

1. An attachment cap unit for shower, comprising:
a head fix unit surrounding the outside of a shower head that water is being sprayed through a plurality of injection holes formed at one side, and positioned at the lower side than one side of the shower head formed the injection holes;
a scalp contact unit is made from a soft materials having an elastic force at the bottom of the head fix unit, and a part of end rim tightly contacted on a scalp; and
a drainpipe installed on one side of the head fix unit and at the lower part than one side of the head fix unit.

2. The attachment cap unit for shower as claimed in claim 1, wherein a hose is connected to the drainpipe and guides a water drained from the injection holes of the shower head.

3. The attachment cap unit for shower as claimed in claim 1, further comprising:
an elastic protrusion attached one side of the shower head on which the injection holes is formed.

4. The attachment cap unit for shower as claimed in claim 1, wherein when the scalp contact unit is tightly contacted on the scalp, a plurality of contact protrusion is separately formed each other at the inside of the scalp contact unit.

5. The attachment cap unit for shower as claimed in claim 1, further comprising:
a shaft installed across the inside of the head fix unit;
a propeller that is installed on the shaft and near the drainpipe, thereby rotating the shaft by using a pressure of water drained to the drainpipe; and
a rotatable protrusion that is installed on the shaft and is being rotated along with the shaft when the shaft is being rotated.
